(19) United States
(12) Patent Application Publication
(10) Pub. No.: US 2022/0281254 A1
(43) Pub. Date: Sep. 8, 2022

(54) Laser Markable Label and Tag

(71) Applicant: AGFA-GEVAERT NV, Mortsel (BE)

(72) Inventors: Dirk Kokkelenberg, Mortsel (BE); Peter Bries, Mortsel (BE); Dirk Quintens, Mortsel (BE)

(73) Assignee: AGFA-GEVAERT NV, Mortsel (BE)

(21) Appl. No.: 17/633,279

(22) PCT Filed: Jul. 16, 2020
(86) PCT No.: PCT/EP2020/070099

§ 371 Date: Feb. 7, 2022

(30) Foreign Application Priority Data
Aug. 8, 2019 (EP) 19190718.7

(51) Int. Cl. B41M 5/26; B29C 48/08; B29C 48/00; C08L 67/02; B29D 7/01; C08J 5/18

(52) U.S. Cl. CPC B41M 5/267; B29C 48/08; B29C 48/022; B29C 48/0018; C08L 67/02; B29D 7/01; C08J 5/18; B29K 2067/003

(57) ABSTRACT

A laser markable label or tag including a polyester film comprising a polyester resin, an optothermal converting agent, a laser markable polymer and titaniumdioxide, characterized in that the amount of titaniumoxide is at least 3 wt % relative to the total weight of the film.

### TECHNICAL FIELD OF THE INVENTION

The present invention relates to laser markable labels and Tags.

### BACKGROUND ART FOR THE INVENTION

Various information such as characters, numbers, images, barcodes, etc. may be provided on a label or a tag. When used in packaging for example, a label may comprise information on the content of the packaging.

Such information is provided on a laser markable label or tag by means of a laser.

An advantage of laser marking instead of conventional printing, such as inkjet or flexographic printing, digital printing (toner) or thermal printing (TSP, thermal transfer, D2T2), is the fact that the information may be provided on the label after providing the label on the packaging. This enables the addition of information, for example expiry dates and/or serial number, at the very end of the packaging process.

Another advantage of laser marking is the fact that the information is provided “in depth”, rendering the marked information more resistant and eliminating the need for a protective layer to be applied after providing the information.

WO2007/063332 (Datalase) disclose a laser markable tape comprising layers of, in order, a tape substrate, a laser markable composition and an adhesive.

WO2016/027061 (Datalase) disclose a method and apparatus for laser marking and laser cutting a label. The laser markable layer also comprises a laser markable composition provided on a substrate.

A disadvantage of laser markable labels wherein a laser markable composition is provided on a substrate, for example between the substrate and an adhesive layer as in WO2007/063332, might be a delamination of the different layers, rendering the laser marked information unreadable. Another disadvantage of a laser markable layer comprising multiple layers is a more complex manufacturing method.

US2018/350271 (Brady Worldwide Inc) disclose a laser markable layer wherein a white layer is provided on top of a black layer and wherein a laser ablates the white layer, resulting in black images on a white background.

A disadvantage of ablation is the formation of debris that has to be removed during the laser marking process. Also, damage of the white layer, for example when the label is already applied on a packaging, may result in loss of the laser marked information.

EP-A 2533981 (Teslin) disclose a polyolefin based microporous material comprising silica, TiO₂ and an optional contrast enhancing material, wherein the sum of TiO₂ and contrast enhancing material is at least 3 wt %.

For some applications, it may be advantageous to provide labels or tags, which have superior physical characteristics such as scratch resistance, flexibility, daylight resistance, solvent resistance, etc. Axially stretched polyester films have such superior physical properties.

WO2008/040670 (Agfa Gevaert) disclose a white, non-transparent, microvoided and axially stretched polyester film. The film contains less than 3 wt % of an inorganic opacifying agent such as BaSO₄ or TiO₂. The manufacturing method to prepare the axially stretched polyester film includes a longitudinal stretching at a tension of preferably higher than 7 N/mm2 to obtain high opacities.

### SUMMARY OF THE INVENTION

It is an object of the present invention to provide a laser markable label or tag having improved physical properties such as flexibility, solvent resistance, scratch resistance, abrasion resistance and weatherability.

That object is realized by the laser markable label or tag as defined in claim 1.

It is another object of the present invention to provide a more efficient and cost effective manufacturing method of such laser markable labels.

Further objects of the invention will become apparent from the description hereinafter.

### BRIEF DESCRIPTION OF THE DRAWINGS

FIG. 1 shows schematically an embodiment of a laser markable label according to the invention.

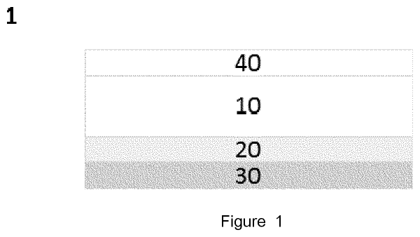

### DETAILED DESCRIPTION OF THE INVENTION

### Laser Markable Label or Tag

The laser markable label or tag according to the present invention includes a polyester film, preferably an axially stretched polyester film, more preferably a biaxially stretched polyester film.

The polyester film preferably consists of a single layer.

The polyester film comprises an optothermal converting agent, a laser markable polymer and at least 3 wt %, relative to the total weight of the film, of titaniumdioxide.

The thickness of the polyester film is preferably between 15 and 1500 μm, more preferably between 25 and 500 μm, most preferably between 75 and 350 μm.

A label as used herein can be affixed to an article, such as a packaging, container or documents. A label typically contains an adhesive for affixing it to the article. The label typically contains information related to the article.

A tag as used herein is a label without adhesive. It is attached to an article by other means, such as tying or hanging. An example of a tag is for example an ear tag used to identify livestock or tags attached to clothing.

The label or tag may be applied on any article for indoor or outdour use.

A preferred laser markable label (1) comprise in addition to the polyester film (10) an adhesive (20), more preferably an adhesive (20) and a release liner (30). To stick such a label onto an article, the release liner is removed and the label is affixed to the article. The adhesive typically requires pressure either by hand or by application equipment.

The laser markable label (1) may also include a printable layer (40). A preferred laser markable label (1) includes and adhesive (20) and a release liner (30) on a side of the axially stretched polyester film (10), and a printable layer (40) on another side of the polyester film.

Such a printable layer facilitates printing of information in addition to the laser marked information. Such a printable layer is preferably sufficiently transparent in the infrared region to enable laser marking of the polyester film and in the visible region to ensure sufficient contrast of the laser marked image.

A release liner is a film, paper, or coated paper material that is coated with for example silicone. The coated side of a release liner preferably has pressure sensitive adhesive applied to it. The release liner protects the adhesive until the label is applied. The silicone coating ensures clean removal of the polyester film and the adhesive from the release liner.

Preferably, a pressure sensitive adhesive is applied to a release liner and then affixed to the polyester film. To stick the label onto an article, the release liner is removed and the label is affixed to the article. The adhesive requires pressure either by hand or by application equipment.

### Polyester Film

A polyester resin is typically prepared in a two-phase production process: an esterification and/or transesterification step of a dicarboxylic acid, or its ester derivative, and a diol compound, followed by a polycondensation step.

Optionally, the resulting polyester after the polycondensation step may be subjected to a so-called solid state polymerization to further increase the Molecular Weight (MW) of the polyester, for example to decrease the amount of terminal carboxyl groups.

Preferred diols are ethyleneglycol, cyclohexane dimethanol and neopentylglycol.

Preferred dicarboxylic acids are ethylene terephthalic acid, ethylene isophthalic acid, butylene terephthalic acid and ethylene 2,6-naphthalic acid.

A preferred polyester is polyethylene terephthalate (PET) wherein the dicarboxylic acid and the diol used in the preparation thereof is respectively ethylene terephthalic acid and ethylene glycol. More preferably a mixture of ethylene terephthalic acid and ethylene isophthalic acid is used to optimize the physical properties of the PET.

Also biopolymers such as polylactic acid (PLA), polybutylene succinate (PBS), polyhydroxyalkanoate (PHA) and polyethylene furanoate (PEF) may be used for preparing the label or tag.

The resulting polyester resin is then fed to a melt extruder to form a polyester film.

The polyester film is then preferably biaxially stretched to form a biaxially oriented polyester (BOPET) film having a specific thickness.

The polyester film preferably comprises at least 50 wt % relative to the total weight of the polyester film, more preferably at least 65 wt % of a polyester as described above.

### Optothermal Converting Agent

The polyester film comprises an optothermal converting agent to improve the laser marking properties of the film.

An optothermal converting agent generates heat upon absorption of radiation.

The optothermal converting agent preferably generates heat upon absorption of infrared (IR) radiation, more preferably near infrared (NIR) radiation.

Near infrared radiation has a wavelength between 750 and 2500 nm.

Optothermal converting agents may be an infrared radiation absorbing dye, an infrared radiation absorbing pigment, or a combination thereof.

It is however important that the optothermal converting agents does not impart unwanted background colouration to the label or tag. This may realized by using only small amounts of the laser additive and/or selecting laser additives that has minimal absorption in the visible region of the spectrum.

Infrared radiation absorbing pigments are for example copper salts as disclosed in WO2005068207, non-stoichiometric metal salts, such as reduced indium tin oxide, as disclosed in WO2007/141522, tungsten oxide or tungstate as disclosed in WO2009/059900, and WO2015/015200. A lower absorption in the visible region while having a sufficient absorption in the near infrared region is an advantage of these tungsten oxides or tungstates, such as Cesium tungsten oxide (CTO).

In a preferred embodiment the optothermal converting agent is carbon black, such as acetylene black, channel black, furnace black, lamp black, and thermal black.

This avoids the use of heavy metals in manufacturing the labels or tags. Heavy metals are less desirable from an ecology point of view and may also cause problems for persons having a contact allergy based on heavy metals.

The use of carbon black pigments as optothermal converting agents may lead to an undesired background colouring of the polyester film. For that reason the numeric average particle size of the carbon black particles is preferably smaller than 100 nm, more preferably smaller than 50 nm, most preferably smaller than 30 nm. The average particle size of carbon black particles can be determined with a Brookhaven Instruments Particle Sizer BI90plus based upon the principle of dynamic light scattering.

Also, to minimize the background colouring of the polyester film, the amount of carbon black is preferably less than 100 ppm, more preferably between 5 and 50 ppm.

Infrared absorbing dyes having substantial no absorption in the visible region may also be used as laser additives. Such dyes, as disclosed in for example WO2014/057018, are particular suitable for use with a NIR laser, for example with a 1064 nm laser.

An advantage of Infrared absorbing dyes (IR dyes) compared to IR pigments is their narrow absorption spectrum resulting in less absorption in the visible region. A disadvantage of such IR dyes is however their limited thermal stability.

Cyanine compounds having a better thermal stability are disclosed in WO2019/007833.

### Laser Markable Polymer

The polyester film comprises a polymer suitable for laser marking, i.e. carbonization, to improve the laser marking properties of the polyester film.

The laser markable polymer is preferably not compatible with the polyester matrix. It has been observed that the laser marking properties, i.e. laser marking density, may be higher when the laser markable polymers are not compatible with the polyester matrix.

Such polymers are selected from the group consisting of polycarbonate (PC), polyvinylchloride (PVC), polystyrene (PS), a styrene-acrylonitrile copolymer (SAN), acrylonitrile butadiene styrene (ABS), polyamide (PA), polyphenyl ether (PPE), polyphenylene sulfide (PPS), polyaryl sulfides, polyaryl sulfones, polyaryl ether ketones, polymethylpentene (PMP), polypropylene (PP), polyethylene (PE) and copolymers of ethylene and propylene.

Preferred laser markable polymers are selected from the group consisting of PS, SAN, PC, PP, PE and PMP.

A particular preferred laser markable polymer is selected from the group consisting of PS and SAN.

The polystyrene polymer may be an atactic polystyrene, an isotactic polystyrene or a syndiotactic polystyrene.

The amount of the laser markable polymer in the polyester film is preferably between 5 and 35 wt %, more preferably between 7.5 and 25 wt %, relative to the total weight of the polyester film.

### Titaniumdioxide

The polyester film comprises at least 3 wt %, preferably at least 5 wt %, most preferably at least 7.5 wt % of titaniumdioxide (TiO₂), all relative to the total weight of the polyester film.

The amount of titaniumdioxide is preferably less than 12 wt %, more preferably less than 10 wt %, all relative to the total weight of the polyester film.

The amount of titaniumdioxide is preferably between 5 and 10 wt % relative to the total weight of the polyester film.

The titaniumdioxide particles may be of the anatase or the rutile type. Preferably titaniumdioxide particles of the rutile type are used due to their higher covering power.

Because titaniumdioxide is UV-sensitive, radicals may be formed upon exposure to UV radiation. Therefore, titaniumdioxide particles are typically coated with Al, Si, Zn or Mg oxides. Preferably such titaniumdioxide particles having an Al₂O₃ or Al₂O₃/SiO₂ coating are used in the present invention.

Other preferred titaniumdioxide particles are disclosed in U.S. Pat. No. 6,849,325 (Mitsubishi polyester film).

### Other Ingredients

The polyester film may further comprise other additives such as optical brighteners, light stabilizers, flame retardants, antimicrobiological agents, antislip agents, antiblocking agents, UV blocking agents, color dyes/pigments, pinning agents, thermal stabilizers, hydrolysis stabilizers, acid scavengers, etc.

### Manufacturing Method of the Polyester Film

The polyester film according to the present invention is preferably prepared using an extrusion process.

The polyester resin, the optothermal converting agent, the laser markable polymer and titaniumdioxide described above are preferably fed to a melt extruder to form a polyester film.

The polyester resin and the laser markable polymer are typically dried before feeding them to the extruder. For example, the polyester resin maybe dried at 135° C. and SAN at 90° C., both under vacuum.

The polyester resin, the optothermal converting agent, the laser markable polymer and the titaniumdioxide may be mixed whereupon that mixture is then added to the extruder.

The laser markable polymer, the optothermal converting agent and the titaniumdioxide are preferably added as a so-called master batch.

A master batch as used herein is a solid product in which additives, for example the optothermal converting agent, the laser markable polymer or titaniumdioxide, are optimally dispersed at high concentration in a carrier material. The carrier material is compatible with the polyester resin in which it will be blended. The carrier material is preferable a polyester resin.

The melt temperature in the extruder is dependent of the type of polyester used. For PET, the melt temperature is preferably from 250 to 320° C., more preferably from 260 to 310° C., most preferably from 270 to 300° C.

The extruder may be a single-screw extruder or a multi-screw extruder. The extruder may be purged with nitrogen to prevent the formation of terminal carboxyl groups through thermal oxidative (or thermo-oxidative) decomposition.

The melt is preferably extruded out through an extrusion die via a gear pump and a filter unit.

The extruded melt is then cooled on one or more chill rolls to form a film thereon.

To enhance the adhesion between the resin melt and the chill roll and to increase the cooling efficiency, static electricity is preferably applied to the chill roll before the melt is brought into contact therewith.

The extruded sheet may then be axially stretched, preferably biaxially stretched.

In biaxial stretching, the order of longitudinal stretching (the Machine Direction (MD) or the running direction of the film) and transverse stretching (Cross Direction (CD) or the width direction) is not specifically defined. Preferably, the longitudinal stretching is carried out first.

The draw ratio in both the longitudinal and the transverse direction is preferably between 2 and 5.

The stretching temperature depends on the type of polyester resin used and is preferably between the glass transition temperature (Tg) of the polyester and Tg+80° C., more preferably between Tg+10° C. and Tg+70° C.

It is preferred that the stretching temperature in the latter stretching, preferably the transverse stretching, is higher than the temperature in the former stretching, preferably the longitudinal stretching.

Longitudinal stretching to prepare a BOPET film is preferably carried out at a force between 4.5 and 7.5 N/mm², more preferably between 5 and 7 N/mm².

Besides this stepwise biaxially stretching method, wherein stretching in a longitudinal direction (longitudinal stretching) and stretching in a width direction (transverse stretching) are performed separately, a simultaneous biaxially stretching method, wherein stretching in a longitudinal direction and stretching in a lateral direction are performed at the same time, may also be used.

In order to complete crystal orientation and to impart flatness and dimensional stability to the biaxially stretched film, the film is preferably subjected to a heat treatment while the sides of the biaxially stretched film are fixed, preferably at a temperature equal or higher than the glass transition temperature (Tg) of the resin but lower than the melting temperature (Tm) thereof. Such a heat treatment is then followed by a uniform and gradual cooling to room temperature.

Such a treatment is often referred to as thermofixation.

It has been observed that thermofixation also influences the laser marking properties, such as the laser marking density, of the polyester film. Thermofixation is preferably carried out at a temperature equal to or higher than the melting temperature (Tmelt) of the polyester film minus 60° C. To prepare a BOPET film the temperature is preferably at least 200° C., more preferably at least 210° C.

In addition to and after the thermofixation, a so called relaxation treatment may be carried out. For a BOPET film, such a relaxation treatment is preferably carried out at a temperature from 80 to 160° C., more preferably from 100 to 140° C. The degree of relaxation is from 1 to 30%, more preferably from 2 to 25%, most preferably from 3 to 20%.

The relaxation may be attained in the lateral or longitudinal direction of the film, or in both directions.

### Method of Laser Marking

Laser marking the polyester film as used herein means marking information in the polyester film by means of a laser due to a color change (carbonization) in the polyester film. Contrary to laser engraving or ablation, wherein a laser removes part of the polyester film, laser marking may not substantially affect the integrity of the polyester film.

The laser used to laser mark the label or tag according to the present invention is preferably an infrared (IR) laser.

The infrared laser may be a continuous wave or a pulsed laser.

For example a CO2 laser, a continuous wave, high power infrared laser having an emission wavelength of typically 10600 nm (10.6 μm) may be used.

CO2 lasers are widely available and cheap. A disadvantage however of such a CO2 laser is the rather long emission wavelength, limiting the resolution of the laser marked information.

To produce high resolution laser marked data, it is preferred to use a near infrared (NIR) laser having an emission wavelength between 780 and 2500, preferably between 800 and 1500 nm in the laser marking step.

A particularly preferred NIR laser is an optical pumped semiconductor laser. Optically pumped semiconductor lasers have the advantage of unique wavelength flexibility, different from any other solid-state based laser. The output wavelength can be set anywhere between about 920 nm and about 1150 nm. This allows a perfect match between the laser emission wavelength and the absorption maximum of an optothermal converting agent present in the laser markable layer.

A preferred pulsed laser is a solid state Q-switched laser. Q-switching is a technique by which a laser can be made to produce a pulsed output beam. The technique allows the production of light pulses with extremely high peak power, much higher than would be produced by the same laser if it were operating in a continuous wave (constant output) mode, Q-switching leads to much lower pulse repetition rates, much higher pulse energies, and much longer pulse durations.

The laser marked “image” comprises data, images, barcodes, etc.

Using a laser marking step to produce an image on a label instead of a conventional printing technique such as inkjet printing, thermal printing or toner printing results in several advantages.

Laser marking does not require post-processing necessary to fix the “printed” image on the label, for example a UV or heat curing. Such post-processing may have a negative influence on the label. In addition, this fact simplifies the process to manufacture the label.

A higher resolution of the image may be obtained because a laser, in combination with a XY-addressable system (for example a galvo-system), can have an addressability of 14000 dots per inch (dpi) or even higher. 14000 dpi correspond with a dot or pixel size of 1.8 μm.

As laser marking is a continuous tone (contone) imaging technique, the density of a single dot on a material can be varied quasi-continuously by changing the laser power. Therefore, there is no need to sacrifice addressability in exchange for producing many gray levels. Offset and inkjet printing and laser marking by ablation are binary techniques, i.e. are only able to produce white or black, or at best multi-level (2, 3, to 8 levels). These printing techniques therefore have to sacrifice addressability in order to be able to produce a multitude of gray levels.

Another advantage of using laser marking instead of conventional printing techniques lies in the fact that a laser can penetrate inside the laser markable layer or even through a transparent layer positioned on top of the laser markable layer and can therefore produce an image inside the layer or a deeper laying layer. Conventional printing techniques on the other hand can only print on the surface of materials. Therefore, an image printed with conventional printing techniques is more prone to damage compared to an image formed inside a laser markable layer by laser marking. To protect an image printed with conventional printing techniques, a coating or varnish may be applied on the printed image. However this means an extra complexity of the production process. So laser marking can produce an image in sub-surface layers without a need to add protection layers afterwards.

Laser marking has a much higher working-distance, meaning the free distance between the label and the front-end of the marking device, for example the lens of the laser. A typical working distance for a laser marking device is of the order of many centimetres, for example 15 cm. In inkjet printing for example, the throwing distance, i.e. distance between the printhead and the packaging, is in the order of millimetres, while offset printing is a contact printing technique.

A larger working distance may be beneficial, for example to laser mark uneven surfaces.

Compared to laser engraving or ablation, less dust is generated with laser marking. Next to that, no chemicals are released in the environment during the imaging process. This is especially of relevance for applications such as pharmaceutical packaging where the GMP (Good Manufacturing Principle) is especially important. To ensure that no dust or chemicals are released during laser marking, a protective transparent layer may be provided on the polyester film through which laser marking is carried out.

Laser marking may be carried before or after the label or tag is attached to an article.

### EXAMPLES

### Materials

All materials used in the following examples were readily available from standard sources such as ALDRICH CHEMICAL Co. (Belgium) and ACROS (Belgium) unless otherwise specified.

PET-01 is polyethylene terephthalate manufactured by Agfa Gevaert.

PET-02 is a polyester comprising 92 mol % terephthalate and 8 mol % isophthalate and 100 mol % ethylene units manufactured by Agfa Gevaert.

SAN is a styrene-acrylonitrile copolymer: DOW SAN124 manufactured by Dow Chemical.

CB-01 is Printex U, a carbon black having an average particle size of 25 nm and a BET of 92 to 100 m²/g available from Orion Engineered Carbons.

OB-01 is an optical brightener available as 4% OB1/96% PET masterbatch from Sukano.

TiO2 is a titanium oxide available as 65% TiO2/35% PET masterbatch from Sukano

BaSO4 is a bariumsulfate available as 50% BASO4/50% PET masterbatch from Sukano.

CaCO3 is a calcium carbonate available as 45% CaCO3/55% PET masterbatch from Sukano.

### Methods

### Laser Marking

The biaxially stretched polyester films obtained in the examples were laser marked using Muhlbauer CLP54 laser equipment.

### Evaluation of the Laser Marked Images

The laser marked images were evaluated by measuring their density, in particular their maximum density (Dmax), minimum density (Dmin), contrast (Dmax−Dmin) and their b-value, in particular the b-value at Dmax.

The density and b-value measurement were carried out on a Gretag Spectro-eye from GretagMacbeth.

The maximum density and the contrast of the laser marked images must be high enough to produce visible images or images that be scanned (for example bar codes).

The laser marked images preferably have a neutral colour.

### Roughness/Gloss of the Film Surfaces

The roughness (Ra and Rz) and the gloss of the surfaces of the polyesters film of the examples were measured using Marsurf PS1 from Mahr.

### Example 1

This examples illustrates the effect of the TiO2 amount on the laser marking properties of a white biaxially stretched polyester (BOPET) film.

ca. 1100 μm thick extrudates with a composition given in Table 1 were biaxially stretched according to the conditions given in Table 2 to provide a white biaxially stretched polyester film having a thickness of ca. 150 μm.

TABLE 1

| Ingredient (wt %) | EX-01 | EX-02 | EX-03 | EX-04 | EX-05 |
|---|---|---|---|---|---|
| PET-01 | 27 | 26 | 25 | 24 | 23 |
| PET-02 | 50 | 49 | 48 | 47 | 46 |
| SAN | 15 | ═ | ═ | ═ | ═ |
| CB-01 | 0.0025 | ═ | ═ | ═ | ═ |
| OB-01 | 0.036 | ═ | ═ | ═ | ═ |
| Ti0₂ | 2 | 4 | 6 | 8 | 10 |
| | EX-06 | EX-07 | EX-08 | EX-09 | EX-10 |
| PET-01 | 22 | 25 | 23 | 25 | 23 |
| PET-02 | 45 | 48 | 46 | 48 | 46 |
| SAN | 15 | ═ | ═ | ═ | ═ |
| CB-01 | 0.0025 | ═ | ═ | ═ | ═ |
| OB-01 | 0.036 | ═ | ═ | ═ | ═ |
| Ti0₂ | 12 | — | — | — | — |
| BaSO₄ | — | 6 | 10 | — | — |
| CaCO₃ | — | — | — | 6 | 10 |

TABLE 2

| Longitudinal Stretch | | Transversal stretch | | |
|---|---|---|---|---|
| Ratio | Force (N) | Ratio | Temp (° C.) | Stretching speed (%/min) |
| 3.3 | 6 | 3.2 | 140-145 | 2000 |

After biaxially stretched film was then subjected to a thermofixation step during 30 seconds at 235-240° C. air temperature.

The obtained white biaxially stretched polyester films (PF-01 to PF-10) were laser marked as described above.

The laser markings were evaluated as described above. The results are given in Table 3.

TABLE 3

Inorganic filler

| | Type | wt % | Dmax | b-value at Dmax |
|---|---|---|---|---|
| PF-01 | Ti02 | 2 | 0.84 | 11.09 |
| PF-02 | Ti02 | 4 | 0.88 | 7.95 |
| PF-03 | Ti02 | 6 | 0.81 | 6.25 |
| PF-04 | Ti02 | 8 | 0.81 | 5.40 |
| PF-05 | Ti02 | 10 | 0.71 | 4.89 |
| PF-06 | Ti02 | 12 | 0.63 | 4.37 |
| PF-07 | BaSO4 | 6 | 0.90 | 21.00 |
| PF-08 | BaSO4 | 10 | 0.66 | 23.10 |
| PF-09 | CaCO3 | 6 | 0.95 | 16.60 |
| PF-10 | CaCO3 | 10 | 0.34 | 18.00 |

It is clear from the results of Table 3 that adding more TiO₂ results in lower b-values. However, also Dmax decreases when more TiO₂ is present. Optimal values (Dmax and b-values) resulting in sufficient laser marking densities (Dmax higher then 0.7) having a neutral colour (b-value lower than 6) are obtained with a biaxially stretched polyester film containing TiO₂ in an amount between 5 and 10 wt %.

It is also clear from Table 3 that with biaxially stretched polyester film containing other inorganic whitening agents instead of TiO₂, such as BaSO₄ or CaCO₃, no neutral laser markings (b-value lower than 6) could be obtained.

### Example 2

This examples illustrates the influence of longitudinal stretching parameters on the laser marking properties of a biaxially stretched polyester film.

A ca. 1100 μm thick extrudate with a composition given in Table 4 was longitudinally stretched using different stretching forces (LD SF) as given in Table 5 followed by transversal stretching at the conditions of Table 2 to provide a white biaxially stretched polyester film having a thickness of ca. 150 μm.

After biaxially stretching, the film was subjected to a thermofixation step at a temperature of 235-240° C. air temperature during 30 seconds.

TABLE 4

| | PET-01 | PET-02 | SAN | Ti02 | CB-01 |
|---|---|---|---|---|---|
| EX-11 | 33 | 50 | 15 | 6 | 0.0025 |

The obtained white biaxially stretched polyester film (PF-11) was laser marked as described above.

The laser markings were evaluated as described above. The results are given in Table 5.

TABLE 5

| LD SF (N) | Contrast |
|---|---|
| 4 | Too brittle |
| 5 | 0.77 |
| 6 | 0.74 |
| 7 | 0.71 |
| 8 | 0.67 |

From the results in Table 5 it is clear that the Longitudinal Stretching Force is preferably higher than 4 N too avoid a too brittle polyester film.

It is also clear that Longitudinal Stretching Forces above 7 N results in lower Laser marking contrasts (below 0.7).

### Example 3

This examples illustrates the influence of thermofixation on the laser marking properties of a biaxially stretched polyester film.

Extrudate EX-11 (see example 2) was biaxially stretched using different stretching forces (LD SF) as given in Table 6 followed by transversal stretching at the conditions of Table 2 to provide a white biaxially stretched polyester film having a thickness of ca. 150 μm.

After biaxially stretching, the films were subjected to a thermofixation step as shown in Table 6 resulting in the biaxially stretched polyester films PF-12 to PF-17.

The obtained biaxially stretched polyester films PF-12 to PF-17 were laser marked as described above.

The laser markings were evaluated as described above. The results are given in Table 6.

TABLE 6

Thermofixation

| | LD SF | T (° C.) film | Time (sec) | Contrast |
|---|---|---|---|---|
| PF-12 | 6 | — | — | 0.54 |
| PF-13 | 6 | 165 | 30 | 0.65 |
| PF-14 | | 200 | 30 | 0.75 |
| PF-15 | | 215 | 30 | 0.78 |
| PF-16 | 8 | — | — | 0.62 |
| PF-17 | 8 | 200 | 30 | 0.74 |

From the result in Table 6 it is clear that carrying out a thermofixation step at a temperature of at least 200° C. results in higher contrasts upon laser marking.

### Example 4

This examples illustrates the influence of the roughness or gloss of the surface of a biaxially stretched polyester film on the laser marking properties.

Extrudate EX-11 (see example 2) was biaxially stretched using the stretching parameters of Table 2 to provide a white biaxially stretched polyester film having a thickness of ca. 150 μm.

After biaxially stretching, the films were subjected to a thermofixation step at a temperature of 235-240° C. during 30 seconds, resulting in the biaxially stretched polyester films PF-18.

Both sides of the polyester film was laser marked as describe above. The results are shown in Table 7.

It was observed that the laser marking properties of both sides of the polyester film PF-18 were different. The difference could be attributed to a different roughness or gloss of both film surfaces, as shown in Table 7

TABLE 7

| Ra (μm) | Rz (μm) | Gloss (75°) | Dmax |
|---|---|---|---|
| 0.561 | 4.17 | 11.2 | 0.72 |
| 0.094 | 0.8 | 120 | 0.66 |

It is clear from the results of Table 7 that a smooth surface having a higher gloss results in a lower laser marking density.

1-15. (canceled)

16. A laser markable label or tag including a polyester film comprising a polyester resin, an optothermal converting agent, a laser markable polymer and titaniumdioxide, characterized in that the amount of titaniumoxide is at least 3 wt % relative to the total weight of the film.

17. The laser markable label or tag of claim 16, wherein the amount of titaniumdioxide is between 5 wt % and 10 wt % relative to the total weight of the film.

18. The laser markable label or tag of claim 16, wherein the amount of titanium oxide is between 6 wt % and 8 wt % relative to the total weight of the film.

19. The laser markable label or tag of claim 16, wherein the optothermal converting agent is carbon black.

20. The laser markable label or tag of claim 19, wherein the amount of carbon black is between 1 to 100 ppm relative to the total weight of the polyester film.

21. The laser markable label or tag of claim 16, wherein the laser markable polymer is selected from the group consisting of polystyrene (PS), styrene-acrylonitrile copolymer (SAN), and polycarbonate (PC).

22. The laser markable label or tag of claim 16, wherein the amount of laser markable polymer is between 5 wt % and 35 wt % relative to the total weight of the film.

23. The laser markable label or tag of claim 16, wherein the polyester film is a polyethylene terephthalate (PET) film.

24. The laser markable label or tag of claim 16, wherein the polyester film is a biaxially stretched polyester film.

25. The laser markable label or tag of claim 16, further comprising an adhesive layer and a release liner.

26. An article comprising a laser markable label or tag as defined in claim 16.

27. A method of preparing a laser markable label or tag, the method comprising:
extruding a polyester film comprising a polyester resin, a laser markable polymer, an optothermal converting agent, and at least 3 wt % titaniumoxide relative to the total weight of the extruded sheet;
longitudinal and transverse stretching the extruded polyester film to form a biaxially stretched polyester film; and
thermofixing the biaxially stretched polyester film.

28. The method of claim 27, wherein the amount of titaniumdioxide is between 5 wt % and 10 wt % relative to the total weight of the polyester sheet.

29. The method of claim 27, wherein longitudinal stretching is carried out at a force between 4.5 N and 7.5 N.

30. The method of claim 27, wherein the thermofixation step is carried out at a temperature of at least the melting temperature of the polyester resin (Tₘₑₗₜ) minus 60° C.
